(19) United States
(12) Patent Application Publication
(10) Pub. No.: US 2015/0382402 A1
(43) Pub. Date: Dec. 31, 2015

(54) Electrically-Heated Clothing/Pants and Its Accessories with Silicone Rubber Heaters

(71) Applicant: PHIHONG TECHNOLOGY CO., LTD., Taoyuan County (TW)

(72) Inventors: Chun-Chen Chen, Taoyuan County (TW); Yu-Ching Huang, Taoyuan County (TW)

(21) Appl. No.: 14/699,717

(22) Filed: Apr. 29, 2015

(30) Foreign Application Priority Data
Jun. 25, 2014 (TW) 103121954

(51) Int. Cl. H05B 3/00; H05B 3/54; H05B 3/18; A41D 13/005

(52) U.S. Cl. CPC H05B 3/0014; A41D 13/0051; H05B 3/54; H05B 3/18

(57) ABSTRACT

Embodiments of the electrically-heated clothing/pants comprising: a clothing/pants, at least one battery, at least one silicone rubber heater and at least one control element. The control element is set firmly on the clothing/pants and electrical coupled with at least one battery and at least one silicone rubber heater; wherein the power of at least one battery could be transferred to at least one silicone rubber heater by turning on at least one control element for converting electrical power to heat.

### FIELD OF THE INVENTION

The present invention relates to an electrically-heated clothing/pants; more particularly, the present invention relates to an electrically-heated clothing/pants and its accessories using silicone rubber heaters as heating devices.

### BACKGROUND OF THE INVENTION

Currently electrically-heated clothing has multiple types of electric heating devices on the market. And wherein the electric heating device may further be of four types: laid electric heating wire, superconductive pellet, knitting conductive yarn and rubber electric heating piece in which the laid electric heating wire forms a high temperature via its contact heating by the way of utilization of laying down the electric heating wire in loops, but the present laid electric heating wire has several common disadvantages comprising: (1) the electric heating wire unevenly distributed leads to heat unevenly and cause to the effect of local overheating; (2) the electric heating wire doesn't have the waterproof itself, and if there is no additional waterproof clothing coated on the electric heating wire, the electric heating wire will produce metal oxidation corrosion in moist environment such as washing the clothes; (3) the electric heating wire sewed in the clothes, coupled with its hard characteristic, influences the shape and touch of the clothes; (4) there is any adhesive force between the electric heating wire and the clothes, thus the electric heating wire is easily dissociated from the clothes; (5) while bending the electric heating wire many times, the bending portion of the electric heating wire is broken easily and cause short circuit and leakage of electricity. Although the lighter carbon fiber heater has replaced the electric heating wire as the improvement technology of heating tools, but the disadvantages of the lighter carbon fiber heater are prohibitive, easily broken while receiving the force hit, absence of ductility and do not be supported under too large stress.

The superconductive pellet electric heating device uses the contacts of thin nickel film etched circuit to heat and form a high temperature, the front and reverse side of the thin nickel film are further attached with Mylar, a multirole plastic material, having the insulating function, while bending the electric heating wire many times, the bending portion of the electric heating wire is broken easily and cause short circuit and leakage of electricity. In addition, the knitting conductive yarn uses fine wire, which is generally metal fibers as the conductive yarn and combines with the silk, then the knitting conductive yarn is sewed in the clothes, the electrically-heated clothing with the knitting conductive yarn electric heating device is more expensive, and because there are many contacts in the knitting conductive yarn, the knitting conductive yarn doesn't loss heating function while fine wire broken unless many fine wire is broken, but the fine wire still has the oxidation problem.

Moreover, the rubber electric heating piece is the safest heater known today. The rubber electric heating piece is made by a compounded rubber pressed and rolled to shape and the wire is embedded in the rubber to form many contacts without circuit problems, the temperature disperses on each area of the rubber equally. Although the rubber electric heating piece has solder contacts, but the solder point temperature doesn't form the aggregate temperature, the rubber electric heating piece may be bended many times without producing the fracture and short circuit condition, the rubber material also has better wear resistance, higher flexibility, higher tensile strength and elongation rate. However, the rubber is aged easily while it is exposed in the air, and the rubber becomes viscous easily on being heated. Additionally, due to currently the cell for commercial electrically-heated clothing use is the 7.4 voltage lithium battery, and the 7.4 voltage lithium battery is not easily purchased on market. Consequently, the 7.4 voltage lithium battery of the clothing is hard to be replaced if it was in trouble. The placement of laid electric heating wire, superconductive pellet, knitting conductive yarn or rubber electric heating piece in commercial electrically-heated clothing is not aimed at the body areas most sensitive to cold.

In addition, in order to keep the human body safe from said electric heating devices, there is one layer or more layers of textiles added between said human body and said electric heating devices, but it will increase the distance between said human body and said electric heating devices and cause the warm ineffectively. Therefore, as previously mentioned, it need to develop a new electrically-heated device for solving many problems as mentioned above.

### SUMMARY OF THE INVENTION

In view of the above known problems, the purpose of the invention is to provide an electrically-heated clothing/pants and its accessories, and the electric heating piece in the electrically-heated clothing/pants and its accessories is a silicone rubber electric heating piece, and the silicone rubber electric heating piece is consisting of a conducting element and a silicone rubber. Apart from its better electrical isolation, the silicone rubber also has better heat conduction and may absorb local thermal energy produced from the conducting element and thermal energy is evenly distributed in the silicone rubber, so it could improve the disadvantage about local overheating, no heat retaining function and no prevention for high temperature while using the electrically-heated clothing/pants and its accessories, the user's surface contacted with the silicone rubber may be heated uniformly, the user is not scalded by the silicone rubber and the silicone rubber may keep the specific body areas warm. In addition, because the silicone rubber has better waterproof function, the electrically-heated clothing/pants will be washed in moist environment such as washing the clothes.

Another purpose of the invention is to provide an improved heater structure of the electrically-heated clothing/pants and its accessories, wherein said conducting element includes but not limited to the cable line, metal alloy foil, conductive adhesive or metal oxide semiconductor, and while the electrically-heated clothing/pants is received the force hit, the silicone rubber may be the buffer for preventing the conducting element from breakage due to bending or hitting said conducting element. The silicone rubber of the silicone rubber electric heating piece may endure temperature up to 250° C., so even if the conducting element has sudden overheating condition, the structure of the silicone rubber still may maintain better stability.

In a first aspect of the invention, the invention of the electrically-heated clothing comprises: a clothing, at least one battery, at least one silicone rubber heater, at least one control element. The at least one control element set on the clothing is electrically connected with at least one battery and at least one silicone rubber heater; wherein the power of at least one battery may be transferred to at least one silicone rubber heater by turning on at least one control element for converting electrical power to heat, wherein said at least one battery may be a 5V lithium battery.

In a second aspect of the invention, the invention of the electrically-heated pants comprises: a pair of pants, at least one battery, at least one silicone rubber heater, at least one control element. The at least one control element set on said pants is electrically connected with at least one battery and at least one silicone rubber heater; wherein the power of at least one battery may be transferred to at least one silicone rubber heater by turning on at least one control element for converting electrical power to heat.

In a third aspect of the invention, the invention of the electrically-heated accessory comprises: an accessory, at least one battery, at least one silicone rubber heater, at least one control element. The at least one control element set on said accessory is electrically connected with at least one battery and at least one silicone rubber heater; wherein the power of at least one battery may be transferred to at least one silicone rubber heater by turning on at least one control element for converting electrical power to heat. In one embodiment, said accessory may further be a belt, gloves and scarf. In one embodiment, some accessories include a bandage, and the bandage may be used for placing said battery.

In a fourth aspect of the invention, said control element of electrically-heated clothing/pants and its accessories further includes: a processor, a temperature detector and a temperature preventer, wherein said temperature detector is coupled with said processor for detecting and maintaining the temperature of the silicone rubber heater, and therefore said silicone rubber heater may keep a constant temperature; said temperature preventer is also coupled with the processor, while the temperature of said silicone rubber heater is abnormal (e.g. excess temperature), the temperature preventer will produce a signal to said processor to disconnect the power source of said battery. In one embodiment, the at least one silicone rubber heater comprises a silicone rubber and a conducting element, wherein the conducting element may further be a cable line, a metal alloy foil, a conductive adhesive or a metal oxide semiconductor. The control element performs multi-stage constant temperature regulation and provides prevention for the abnormal temperature to control electrical power which is transmitted from at least one battery to at least one silicone rubber heater and achieve the effect of temperature constant and control.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 is illustrated as a diagram of basic structure of an electrically-heated clothing.

FIG. 2 is illustrated as a diagram of basic structure of an electrically-heated pair of pants.

FIG. 3 is illustrated an electrically-heated accessory according to one embodiment.

FIG. 4 is illustrated another electrically-heated accessory according to one embodiment.

FIG. 5 is illustrated as a diagram of silicone rubber heater structure.

### DETAILED DESCRIPTION OF THE PRESENT INVENTION

An implementation of the invention is illustrated by the following specific embodiments, the person who is familiar with the technique may easily realize the efficiency and its advantages disclosed from the specification content. The invention also may use other specific embodiments to utilize and implement, each detail illustrated in the specification may be applied based on different needs and various kinds of modifications and alterations are not departed under the spirit of the invention.

Some sample embodiments of the invention will now be described in greater detail. Nevertheless, it should be recognized that the present invention can be practiced in a wide range of other embodiments besides those explicitly described, and the scope of the present invention is expressly not limited expect as specified in the accompanying claims.

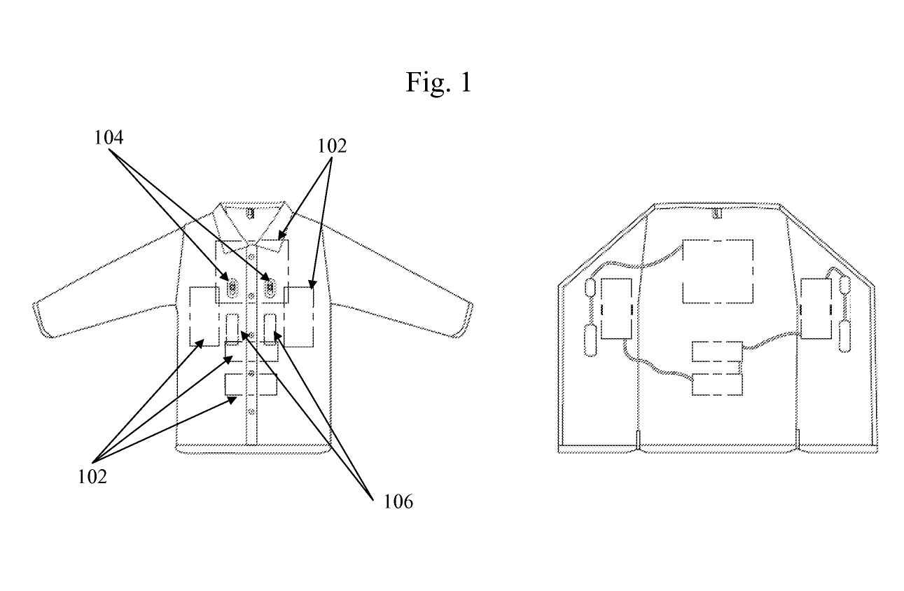

As shown in FIG. 1, it is illustrated as a diagram of basic structure of an electrically-heated clothing. The embodiment of the electrically-heated clothing further includes: a clothing, at least one battery 106, at least one silicone rubber heater 102 and at least one control element 104, wherein the at least one control element set on said clothing is electrically connected with at least one battery and at least one silicone rubber heater; wherein the power of at least one battery may be transferred to at least one silicone rubber heater by turning on at least one control element for converting electrical power to heat. In one embodiment, wherein a plurality of pockets are sewed on the clothing, several pockets on the front of clothing and the at least one battery is placed separately in the plurality of pockets. Wherein there are a plurality of pockets sewed on the front and back of the clothing, and said silicone rubber heaters are placed separately in the plurality of pockets.

In some embodiments, there are two pockets sewed on the front of electrically-heated clothing, and there are three pockets sewed on the back of electrically-heated clothing, then the silicone rubber heaters are placed separately in said pockets. The presentation of heaters in the front of electrically-heated clothing is designed for keeping the chest and heart areas warm; additionally, the presentation of silicone rubber heaters in the back of electrically-heated clothing is designed for keeping the back and waist areas warm.

In one embodiment, wherein the at least one battery used by the electrically-heated clothing is the 5V lithium battery. In one embodiment, the battery used by the electrically-heated clothing is a graphene battery.

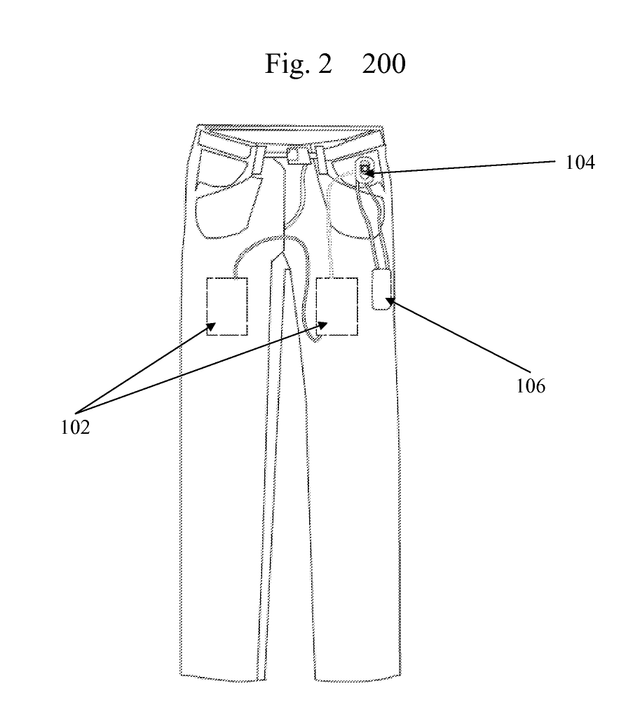

As shown in FIG. 2, it is illustrated as a diagram of basic structure of an electrically-heated pair of pants. The embodiment of the electrically-heated pair of pants 200 further includes: a pair of pants, at least one silicone rubber heater 102, at least one control element 104, at least one battery 106, wherein the at least one control element set on said pants is electrically connected with at least one battery and at least one silicone rubber heater; wherein the power of at least one battery may be transferred to at least one silicone rubber heater by turning on at least one control element for converting electrical power to heat; wherein said at least one battery may be a 5V lithium battery. In one embodiment, wherein a plurality of pockets are sewed on the leg of pants, and the at least one battery is placed separately in the plurality of pockets. In one embodiment, wherein a plurality of pockets are sewed on the electrically-heated pair of pants, several pockets on the seat of pants and several pockets on the leg of pants, and said silicone rubber heaters are placed separately in the plurality of pockets. In one embodiments, the battery used by the electrically-heated pair of pants may be a graphene battery. In another embodiment, wherein the at least one silicone rubber heater of the electrically-heated clothing/pants may be electrically connected with other silicone rubber heaters via a wire.

In some embodiments, there are two pockets sewed on the pair of pants, then the batteries are placed separately in said pockets. In one embodiment, there are three pockets sewed on the pair of pants, one pocket on the seat of pants and two pockets on the leg of pants, then the at least one silicone rubber heater is placed separately in said pockets. The presentation of heaters in the electrically-heated pair of pants is designed for keeping the back of seat and leg areas warm.

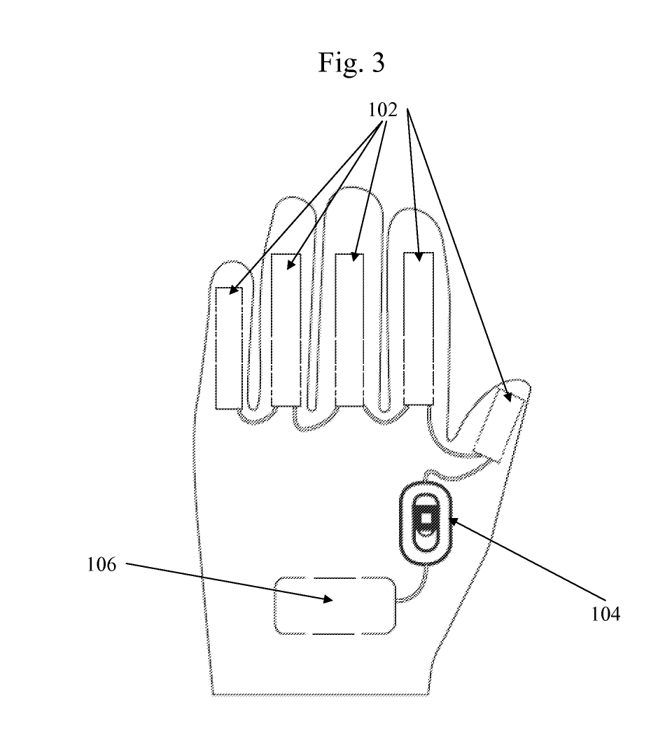

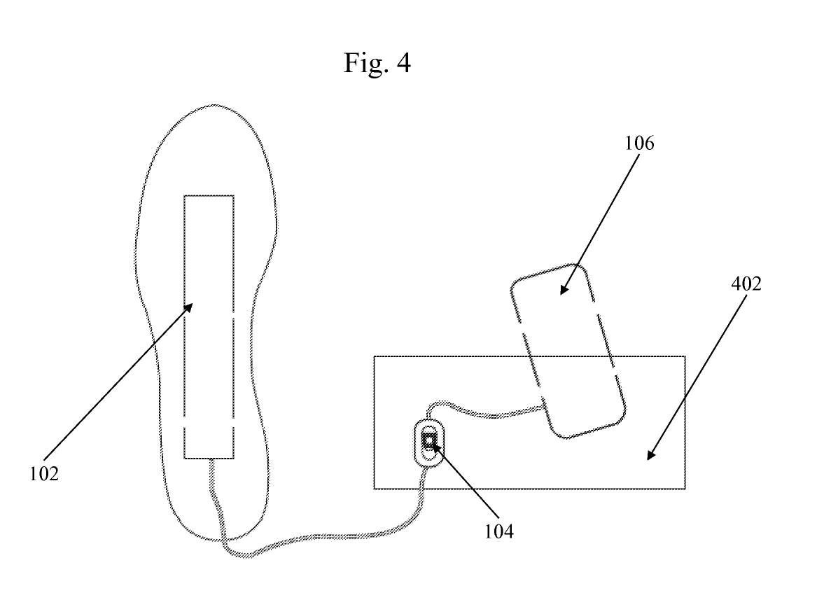

As shown in FIG. 3, it is illustrated an electrically-heated accessory according to one embodiment. The embodiment of the electrically-heated accessory further includes: an accessory, at least one silicone rubber heater 102, at least one battery 106, at least one control element 104, wherein the at least one control element set on said accessory is electrically connected with at least one battery and at least one silicone rubber heater; wherein the power of at least one battery may be transferred to at least one silicone rubber heater by turning on at least one control element for converting electrical power to heat; wherein there is at least one pocket sewed on the accessory for placing the at least one control element and the at least one battery; wherein a plurality of pockets are sewed on the accessory, and said at least one silicone rubber heater is placed separately in said plurality of pockets. In one embodiment, the accessory may also be the gloves, belt and scarf. In another embodiment, as shown in FIG. 4, some accessories (e.g. insole and earmuffs) include a bandage 402, and there is at least one pocket sewed on said bandage for placing at least one battery. In one embodiment, said battery is the 5V lithium battery.

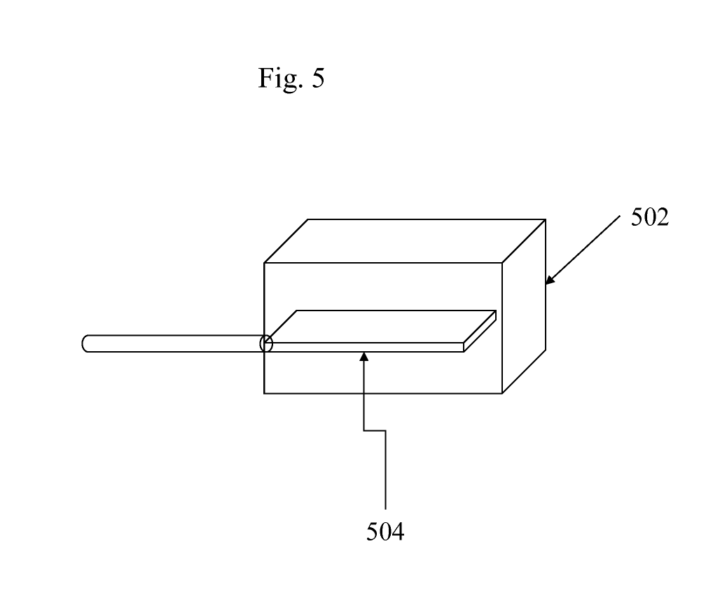

As shown in FIG. 5, it is illustrated as a diagram of silicone rubber heater structure. In some embodiments, said silicone rubber heater used in the electrically-heated clothing/pants comprises: a silicone rubber 502 and a conducting element 504, and the conducting element may further be one of a cable line, a metal alloy foil, a conductive adhesive and a metal oxide semiconductor. In some embodiments, said silicone rubber is used as an insulator to coat the conducting element completely, the silicone rubber may fully absorb thermal energy produced from the conducting element. In some embodiments, the conducting element 504 is a tablet-shaped structure or a plurality of microstructures, and the plurality of microstructures is arranged in a pattern selected from the group consisting of one or more pattern, a spiral pattern, a horseshoe pattern, a herringbone pattern, one or more herringbone pattern, one or more pattern of clustered microstructures, and various combinations thereof. In some embodiments, the conducting element may further be bent to “U” type or “S” type, then placed in the silicone rubber 502.

In one specific embodiment, while the holes of the silicone rubber of the silicone rubber heater are 7.5˜8.5 mm in diameter used in the electrically-heated clothing/pants and its accessories, the silicone rubber heater may still maintain the temperature range that is desirable when the control element switches different output of electrical power; in another embodiment, said holes of the silicone rubber of said silicone rubber heater with a diameter of 8 mm are optimal.

In another embodiment, the control element of the electrically-heated clothing/pants and its accessories may further be analog controller, logic circuit and microcontroller, wherein the controller may use a multi-stage switch to regulate the amount electrical power which is transmitted from said at least one battery to said at least one silicone rubber heater, and said control element further include: a processor, a temperature detector and a temperature preventer, wherein said temperature detector is coupled with said processor for detecting and maintaining the temperature of the silicone rubber heater; said temperature preventer is also coupled with the processor, and the temperature preventer will produce another signal to disconnect the power source of said battery. In one embodiment, while said silicone rubber heater is achieved a constant temperature, said processor will receive a signal provided by said temperature detector for regulating other element (e.g. a pulse-width modulator) to achieve a constant temperature of the silicone rubber heater; while the temperature of said silicone rubber heater is abnormal (e.g. excess temperature), said temperature preventer will produce and provide another signal for the processor to disconnect the power source of said battery. In one embodiment, the control element may use three-stage switch to provide said at least one silicone rubber heater for three different temperature ranges. The at least one controller may further be coupled with a light-emitting diode, and the light color of said light-emitting diode indicates the temperature range of the surface of silicone rubber heater, therefore, while using the electrically-heated clothing/pants, the user may know the temperature range of the surface of silicone rubber heater through the light color of said light-emitting diode.

The foregoing preferred embodiment of the present invention is illustrative of the present invention rather than limiting the present invention. Having described the invention in connection with a preferred embodiment, modification will now suggest itself to those skilled in the art. Thus, the invention is not to be limited to this embodiment, but rather the invention is intended to cover various modifications and similar arrangements included within the spirit and scope of the appended claims, the scope of which should be accorded the broadest interpretation so as to encompass all such modifications and similar structures. While the preferred embodiment of the invention has been illustrated and described, it will be appreciated that various changes can be made therein without departing from the spirit and scope of the invention.

We claim:

1. An electrically-heated clothing, comprising:
a clothing;
at least one battery;
at least one silicone rubber heater including a silicone rubber and a conducting element;
at least one control element set on said clothing, electrically connected with said at least one battery and said at least one silicone rubber heater, and further comprising:
a process; and
a temperature detector coupled with said processor for detecting and maintaining the temperature of silicone rubber heater;
a temperature preventer coupled with said processor, while the temperature of silicone rubber heater is abnormal, the temperature preventer produces a signal to said processor to disconnect the power source of at least one battery; wherein the power of at least one battery is transferred to said at least one silicone rubber heater by turning on said at least one control element for converting electrical power to heat.

2. An electrically-heated pants, comprising:
a pair of pants;
at least one battery;
at least one silicone rubber heater including a silicone rubber and a conducting element;
at least one control element set on said pants, electrically connected with said at least one battery and said at least one silicone rubber heater, and further comprising:
a process; and
a temperature detector coupled with said processor for detecting and maintaining the temperature of silicone rubber heater;
a temperature preventer coupled with said processor, while the temperature of silicone rubber heater is abnormal, the temperature preventer produces a signal to said processor to disconnect the power source of at least one battery; wherein the power of at least one battery is transferred to said at least one silicone rubber heater by turning on said at least one control element for converting electrical power to heat.

3. The clothing of claim 1, wherein said at least one silicone rubber heater is electrically connected with other silicone rubber heaters.

4. The clothing of claim 1, wherein said conducting element is one of cable line, metal alloy foil, conductive adhesive or metal oxide semiconductor.

5. The clothing of claim 1, wherein said conducting element is a tablet-shaped structure or a plurality of microstructures, and said plurality of microstructures is arranged in a pattern selected from the group consisting of one or more pattern, a spiral pattern, a horseshoe pattern, a herringbone pattern, one or more herringbone pattern, one or more pattern of clustered microstructures, and various combinations thereof.

6. The clothing of claim 1, wherein said conducting element is further bent to “U” type or “S” type and placed in said silicone rubber.

7. The clothing of claim 1, wherein said holes of silicone rubber of the silicone rubber heater are 7.5˜8.5 mm in diameter.

8. The clothing of claim 1, wherein said holes of said silicone rubber of silicone rubber heater are 8 mm in diameter.

9. The clothing of claim 1, wherein there are several pockets sewed on the front of clothing, then the at least one battery is placed separately in said pockets.

10. The pants of claim 2, wherein there are two pockets sewed on the pair of pants, then the at least one battery is placed separately in said pockets.

11. The pants of claim 2, wherein there are three pockets sewed on the pair of pants, one pocket on the seat of pants and two pockets on the leg of pants, and the at least one silicone rubber heater is placed separately in said pockets.

12. The pants of claim 2, wherein said conducting element is a tablet-shaped structure or a plurality of microstructures, and said plurality of microstructures is arranged in a pattern selected from the group consisting of one or more pattern, a spiral pattern, a horseshoe pattern, a herringbone pattern, one or more herringbone pattern, one or more pattern of clustered microstructures, and various combinations thereof.

13. The clothing of claim 1, wherein said at least one control element regulates said amount electrical power which is transmitted from said at least one battery.

14. The clothing of claim 1, wherein the at least one battery is a 5V lithium battery.

15. The clothing of claim 1, wherein the at least one battery is a graphene battery.

16. An electrically-heated accessory, comprising:
an accessory;
at least one battery;
at least one silicone rubber heater including a silicone rubber and a conducting element;
at least one control element set on said accessory, electrically connected with said at least one battery and said at least one silicone rubber heater, and further comprising:
a process; and
a temperature detector coupled with said processor for detecting and maintaining the temperature of silicone rubber heater;
a temperature preventer coupled with said processor, while the temperature of silicone rubber heater is abnormal, the temperature preventer produces a signal to said processor to disconnect the power source of at least one battery; wherein the power of at least one battery is transferred to said at least one silicone rubber heater by turning on said at least one control element for converting electrical power to heat.

17. The accessory of claim 16, wherein said accessory is further a belt, gloves or scarf.

18. The accessory of claim 16, wherein said accessory is further an insole or earmuffs.

19. The accessory of claim 18, wherein said insole further includes a bandage, said bandage is used for placing said at least one battery.

20. The accessory of claim 16, wherein the at least one battery is a 5V lithium battery.

21. The accessory of claim 16, wherein said conducting element is a tablet-shaped structure or a plurality of microstructures, and said plurality of microstructures is arranged in a pattern selected from the group consisting of one or more pattern, a spiral pattern, a horseshoe pattern, a herringbone pattern, one or more herringbone pattern, one or more pattern of clustered microstructures, and various combinations thereof.
